(19) United States
(12) Patent Application Publication
(10) Pub. No.: US 2026/0362266 A1
(43) Pub. Date: Nov. 12, 2026

(54) METHODS AND APPARATUSES OF SUPPORTING LOWER LAYER MOBILITY

(71) Applicant: Lenovo (Beijing) Limited, Beijing (CN)

(72) Inventors: Shuigen Yang, Shanghai (CN); Mingzeng Dai, Shanghai (CN); Lianhai Wu, Beijing (CN); Congchi Zhang, Shanghai (CN)

(73) Assignee: Lenovo (Beijing) Limited, Beijing (CN)

(21) Appl. No.: 19/111,912

(22) PCT Filed: Sep. 27, 2022
(86) PCT No.: PCT/CN2022/121644

§ 371 Date: Mar. 14, 2025

(51) Int. Cl. H04W 36/08

(52) U.S. Cl. CPC H04W 36/08

(57) ABSTRACT

The present application relates to of methods and apparatuses of supporting lower layer mobility. An embodiment of the present disclosure provides a distributed unit (DU), including: a transceiver; and a processor coupled with the transceiver and configured to: determine a candidate cell configuration and an index of the candidate cell configuration for each candidate cell of one or more candidate cells, wherein the index of the candidate cell configuration is generated by the DU or received from other network node; and transmit, to a user equipment (UE), an indication indicating the UE to handover from a serving cell to a candidate cell of the one or more candidate cells.

### TECHNICAL FIELD

The present disclosure relates to wireless communication, and particularly relates to methods and apparatuses of supporting lower layer mobility.

### BACKGROUND OF THE INVENTION

A user equipment (UE) may move from one cell to another cell, and thus at some points, a serving cell change needs to be performed.

At present, the serving cell change is performed by explicit radio resource control (RRC) reconfiguration signalling to trigger the synchronization of target cell based on layer 3 (L3) measurements report. It leads to longer latency, larger overhead, and longer interruption time than beam level mobility.

In 3^{rd} generation partnership project (3GPP) Release 18, a new work item on further new radio (NR) mobility enhancements was approved to enable a serving cell change via lower layer signaling, e.g., layer 1 (L1) or layer 2 (L2) signalling, in order to reduce the latency, overhead and interruption time.

Thus, how to support lower layer mobility will be studied and solved.

### SUMMARY

One objective of the present disclosure is to propose to some solutions of supporting lower layer mobility.

An embodiment of the present disclosure provides a distributed unit (DU), including: a transceiver; and a processor coupled with the transceiver and configured to: determine a candidate cell configuration and an index of the candidate cell configuration for each candidate cell of one or more candidate cells, wherein the index of the candidate cell configuration is generated by the DU or received from other network node; and transmit, to a user equipment (UE), an indication indicating the UE to handover from a serving cell to a candidate cell of the one or more candidate cells.

In some embodiments, the indication is transmitted via medium access control (MAC)-control element (CE) or downlink control information (DCI).

In some embodiments, the indication indicates at least one of the following: an index of a candidate cell configuration corresponding to the candidate cell; or an indicator indicating whether the candidate cell configuration is to be maintained.

In some embodiments, the processor is further configured to: receive, from a central unit (CU), a first message indicating a candidate cell configuration and an index of candidate cell configuration for each candidate cell of a set of candidate cells, wherein the set of candidate cells includes the one or more candidate cells; and transmit, to the CU, a second message indicating the candidate cell configuration and the index of the candidate cell configuration for each candidate cell of one or more candidate cells.

In some embodiments, the processor is further configured to: receive, from a CU, a first message indicating a candidate cell configuration for each candidate cell of a set of candidate cells; determine the one or more candidate cells from the set of candidate cells; generate an index for each candidate cell configuration for each candidate cell of the one or more candidate cells; and transmit, to the CU, a second message indicating the candidate cell configuration and the index of the candidate cell configuration for each candidate cell of the one or more candidate cells.

In some embodiments, the processor is further configured to: receive, from a CU, a first message indicating a set of candidate cells; determine the one or more candidate cells from the set of candidate cells; generate a candidate cell configuration and an index for each candidate cell configuration for each candidate cell of the one or more candidate cells; and transmit, to the CU, a second message indicating the candidate cell configuration and the index of the candidate cell configuration for each candidate cell of the one or more candidate cells.

In some embodiments, the processor is further configured to: receive, from a CU, a first message indicating a set of candidate cells; determine the one or more candidate cells from the set of candidate cells; generate a candidate cell configuration for each candidate cell of the one or more candidate cells; and transmit, to the CU, a second message indicating the candidate cell configuration for each candidate cell of the one or more candidate cells.

In some embodiments, the candidate cell configuration includes at least one of the following: a channel state information (CSI) resource configuration; or a state of transmission configuration indicator.

Another embodiment of the present disclosure provides a CU, including: a transceiver; and a processor coupled with the transceiver and configured to: transmit a first message at least indicating a set of candidate cells; and receive a second message indicating a candidate cell configuration and an index of candidate cell configuration for each candidate cell of one or more candidate cells of the set of candidate cells.

In some embodiments, the first message further indicates a candidate cell configuration for each candidate cell of the set of candidate cells, the processor is further configured to: transmit, to a candidate DU, a request message indicating at least one candidate cell; and receive a response message indicating a candidate cell configuration for each candidate cell of at least a part of the at least one candidate cell.

In some embodiments, the first message further indicates an index for each candidate cell configuration for each candidate cell of a set of candidate cells.

In some embodiments, the processor is further configured to: determine an index for each candidate cell configuration for each candidate cell of at least a part of the at least one candidate cell.

In some embodiments, the processor is further configured to: transmit, to a candidate DU, a request message indicating at least one candidate cell and an index range; and receive a response message indicating a candidate cell configuration and an index of candidate cell configuration for each candidate cell of at least a part of the at least one candidate cell.

In some embodiments, the processor is further configured to: transmit, to a UE, a message indicating the candidate cell configuration and the index of candidate cell configuration for each candidate cell of one or more candidate cells.

In some embodiments, the candidate cell configuration includes at least one of the following: a CSI resource configuration; or a state of transmission configuration indicator.

Yet another embodiment of the present disclosure provides a UE, including: a transceiver; and a processor coupled with the transceiver and configured to: receive, a message indicating a candidate cell configuration and an index of candidate cell configuration for each candidate cell of one or more candidate cells; and in response to receiving an indication indicating the UE to handover from a serving cell to a candidate cell of the one or more candidate cells, perform a random access procedure towards the candidate cell.

In some embodiments, the indication is received via MAC CE, or DCI.

In some embodiments, the indication indicates at least one of the following: an index of a candidate cell configuration corresponding to the candidate cell; or an indicator indicating the candidate cell configuration is to be maintained.

In some embodiments, the candidate cell configuration includes at least one of the following: a CSI resource configuration; or a state of transmission configuration indicator.

Yet another embodiment of the present disclosure provides a method of supporting lower layer mobility, including: determining a candidate cell configuration and an index of the candidate cell configuration for each candidate cell of one or more candidate cells, wherein the index of the candidate cell configuration is generated by the DU or received from other network node; and transmitting, to a UE, an indication indicating the UE to handover from a serving cell to a candidate cell of the one or more candidate cells.

Yet another embodiment of the present disclosure provides a method of supporting lower layer mobility, including: transmitting a first message at least indicating a set of candidate cells; and receiving a second message indicating a candidate cell configuration and an index of candidate cell configuration for each candidate cell of one or more candidate cells of the set of candidate cells.

Yet another embodiment of the present disclosure provides a method of supporting lower layer mobility, including: receiving a message indicating a candidate cell configuration and an index of candidate cell configuration for each candidate cell of one or more candidate cells; and in response to receiving an indication indicating the UE to handover from a serving cell to a candidate cell of the one or more candidate cells, performing a random access procedure towards the candidate cell.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1A illustrates a schematic diagram of an intra-CU intra-DU mobility scenario according to some embodiments of the present disclosure.

FIG. 1B illustrates a schematic diagram of an intra-CU inter-DU mobility scenario according to some embodiments of the present disclosure.

FIG. 2 illustrates a method performed by a source DU according to some embodiments of the present disclosure.

FIG. 3 illustrates a method performed by a CU according to some embodiments of the present disclosure.

FIG. 4 illustrates a method performed by a UE according to some embodiments of the present disclosure.

FIG. 5 illustrates a flow chart of supporting lower layer mobility in an inter-DU mobility scenario according to some embodiments of the present disclosure.

FIG. 6 illustrates a structure of an indication according to some embodiments of the present disclosure.

FIG. 7 illustrates a flow chart of supporting lower layer mobility in an inter-DU mobility scenario according to some embodiments of the present disclosure.

FIG. 8 illustrates a flow chart of supporting lower layer mobility in an inter-DU mobility scenario according to some embodiments of the present disclosure.

FIG. 9 illustrates a flow chart of supporting lower layer mobility in an intra-DU mobility scenario according to some embodiments of the present disclosure.

FIG. 10 illustrates a flow chart of supporting lower layer mobility in an intra-DU mobility scenario according to some embodiments of the present disclosure.

FIG. 11 illustrates a simplified block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, a LTE network, a 3GPP-based network, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

The main objectives regarding further mobility enhancements may include:
Configuration and maintenance for multiple candidate cells to allow fast application of configurations for candidate cells.
Dynamic switch mechanism among candidate serving cells for the potential applicable scenarios.

The potential applicable scenarios of lower layer mobility may include intra-CU intra-DU mobility and intra-CU inter-DU mobility. In the present disclosure, the lower layer mobility is compared to the legacy L3 mobility based on RRC signalling, e.g., L1 or L2 mobility based on L1 or L2 signalling.

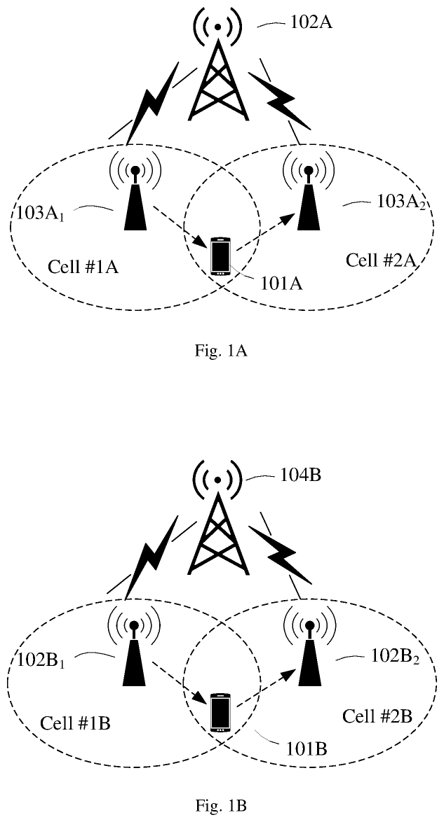

FIG. 1A illustrates a schematic diagram of an intra-CU intra-DU mobility scenario according to some embodiments of the present disclosure.

The wireless communication system in FIG. 1A includes a DU (e.g., DU 102A), a UE (e.g. UE 101A), and some access nodes (e.g. access node 103A₁ and access node 103A₂). The access node 103A₁ and access node 103A₂ are controlled by the DU 102A, and provides services for UEs within cell #1A and cell #2A respectively. Even though there are only one UE and two access nodes in FIG. 1A, persons skilled in the art will recognize that any number of UEs and access nodes may be included in the wireless communication system.

UE 101A may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, modems), or the like. According to an embodiment of the present disclosure, UE 101A may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 101A includes wearable devices, such as smart watches, fitness bands, optical head-mounted displays, or the like. Moreover, UE 101A may be referred to as subscriber units, mobiles, mobile stations, users, terminals, mobile terminals, wireless terminals, fixed terminals, subscriber stations, user terminals, a device, or by other terminology used in the art.

The access nodes 103A₁ and 103A₂ may be distributed over a geographic region. In certain embodiments, a access node may also be referred to as an access point, an access terminal, a base, a base station, a macro cell, a node-B, an enhanced node B (eNB), a gNB, a home node-B, a relay node, a device, or by any other terminology used in the art. The access nodes 103A₁ and 103A₂ may be generally a part of a radio access network that may include one or more controllers communicably coupled to one or more corresponding base stations.

The wireless communication system is compliant with any type of network that is capable of sending and receiving wireless communication signals. For example, the wireless communication system is compliant with a wireless communication network, a cellular telephone network, a TDMA-based network, a CDMA-based network, an OFDMA-based network, a long-term evolution (LTE) network, a 3GPP-based network, 3GPP 5G network, a satellite communications network, a high altitude platform network, and/or other communications networks.

In one implementation, the wireless communication system is compliant with the NR of the 3GPP protocol, wherein the transmission may be performed using an OFDM modulation scheme. More generally, the wireless communication system may implement some other open or proprietary communication protocol, for example, WiMAX, among other protocols.

In other embodiments, the transmission may be performed using other communication protocols, such as the IEEE 802.11 family of wireless communication protocols. Further, in some embodiments the transmission may be performed over licensed spectrum, while in other embodiments the transmission may be performed over unlicensed spectrum. The present disclosure is not intended to be limited to the implementation of any particular wireless communication system architecture or protocol. In another embodiment, the transmission may be performed using the 3GPP 5G protocols.

In FIG. 1A, UE 101A is moving from cell #1A to cell #2A, and may perform a handover procedure from cell #1A to access to cell #2A, which is a handover procedure performed between different cells within a DU. This scenario may be referred to as intra-CU intra-DU mobility. In short, this scenario may be called as intra-DU mobility.

FIG. 1B illustrates a schematic diagram of an intra-CU inter-DU mobility scenario according to some embodiments of the present disclosure.

The wireless communication system in FIG. 1B includes a CU (e.g., CU 104B), a UE (e.g. UE 101B), and some DUs (e.g. DU 102B₁ and DU 102B₂). The DU 102B₁ and DU 102B₂ are controlled by CU 104B, and provides services for UEs within cell #1B and cell #2B respectively. Even though there are only one UE and two DUs in FIG. 1B, persons skilled in the art will recognize that any number of UEs and DUs may be included in the wireless communication system.

In FIG. 1B, UE #101B is moving from cell #1B to cell #2B, and may perform a handover procedure from cell #1B to access to cell #2B, which is a handover procedure performed between different cells belonging to different DUs but within the same CU. This scenario may be referred to as intra-CU intra-DU mobility. In short, this scenario may be called as inter-DU mobility.

For the lower layer mobility, the following issues will be addressed:

### Issue 1

If the mobility to a different cell is needed for the UE, the network may trigger the UE to change from the current source cell to the target candidate cell. The cell ID with 32 bits and physical cell identity (PCI) with 10 bits are used in the legacy L3 signalling, which causes overhead in L1 or L2 signalling.

Therefore, the present disclosure proposes a more efficient solution to reduce signalling overhead in L1 or L2 signalling. Specifically, the present disclosure proposes to introduce an index indicating a candidate cell configuration.

### Issue 2

In the inter-DU mobility scenario, for example, the scenario as shown in FIG. 1B, the candidate cell configuration is generated by the candidate DU and sent to the CU via an information element (IE), e.g. CellGroupConfig, which is transparent for the CU.

If the index based approach as proposed in issue 1 is used, it is necessary that there is no conflict or confusion among the generated index of the candidate cell configuration of different candidate DUs. Furthermore, the source DU and the UE need to have common understanding of the index.

### Issue 3

In the intra-DU mobility scenario, it is also needed to determine which node generates the index of the candidate cell configuration.

The present disclosure proposes some solutions at least for solving the above issues.

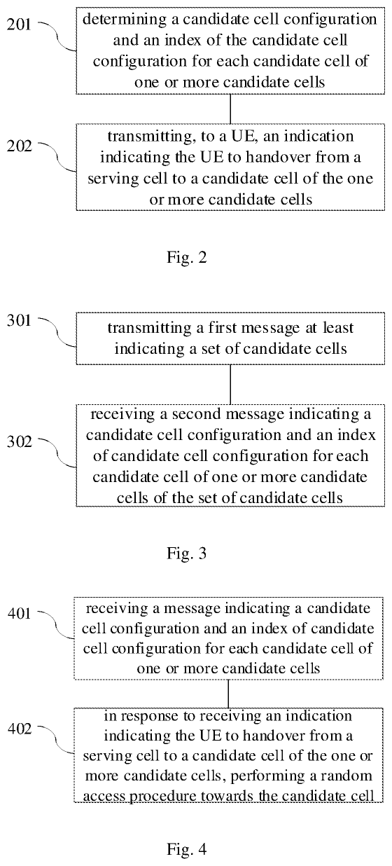

FIG. 2 illustrates a method performed by a DU, e.g., a source DU according to some embodiments of the present disclosure.

In operation 201, the source DU may determine a candidate cell configuration and an index of the candidate cell configuration for each candidate cell of one or more candidate cells (e.g. N candidate cells, where N is an integer), wherein the index of the candidate cell configuration is generated by the DU or received from other network node; and in operation 202, the source DU may transmit, to a UE, an indication indicating the UE to handover from a serving cell to a candidate cell of the one or more candidate cells.

In some embodiments, the indication is transmitted via MAC CE or DCI.

In some embodiments, the indication may indicate at least one of the following:
an index of a candidate cell configuration corresponding to the candidate cell; or
an indicator indicating whether the candidate cell configuration is to be maintained.

In some embodiments, the DU may receive, from a CU, a first message (e.g. a UE CONTEXT MODIFICATION REQUEST message) indicating a candidate cell configuration and an index of candidate cell configuration for each candidate cell of a set of candidate cells (e.g. M candidate cells, where M is an integer, and is equal to or larger than N), wherein the set of candidate cells includes the one or more candidate cells (e.g. M candidate cells); and transmit, to the CU, a second message (e.g. a UE CONTEXT MODIFICATION RESPONSE message) indicating the candidate cell configuration and the index of the candidate cell configuration for each candidate cell of one or more candidate cells.

In some embodiments, the DU may receive, from a CU, a first message (e.g. a UE CONTEXT MODIFICATION REQUEST message) indicating a candidate cell configuration for each candidate cell of a set of candidate cells (e.g. M candidate cells); determine the one or more candidate cells (e.g. N candidate cells) from the set of candidate cells (e.g. M candidate cells); generate an index for each candidate cell configuration for each candidate cell of the one or more candidate cells; and transmit, to the CU, a second message (e.g. a UE CONTEXT MODIFICATION RESPONSE message) indicating the candidate cell configuration and the index of the candidate cell configuration for each candidate cell of the one or more candidate cells.

In some embodiments, the DU may receive, from a CU, a first message (e.g. a UE CONTEXT MODIFICATION REQUEST message) indicating a set of candidate cells (e.g. M candidate cells); determine the one or more candidate cells (e.g. N candidate cells) from the set of candidate cells; generate a candidate cell configuration and an index for each candidate cell configuration for each candidate cell of the one or more candidate cells; and transmit, to the CU, a second message indicating the candidate cell configuration and the index of the candidate cell configuration for each candidate cell of the one or more candidate cells.

In some embodiments, the DU may receive, from a CU, a first message (e.g. a UE CONTEXT MODIFICATION REQUEST message) indicating a set of candidate cells; determine the one or more candidate cells (e.g. N candidate cells) from the set of candidate cells (e.g. M candidate cells); generate a candidate cell configuration for each candidate cell of the one or more candidate cells; and transmit, to the CU, a second message (e.g. a UE CONTEXT MODIFICATION RESPONSE message) indicating the candidate cell configuration for each candidate cell of the one or more candidate cells.

In some embodiments, the candidate cell configuration includes at least one of the following:
a CSI resource configuration; or
a state of transmission configuration indicator.

FIG. 3 illustrates a method performed by a CU according to some embodiments of the present disclosure.

In operation 301, the CU may transmit a first message (e.g. a UE CONTEXT MODIFICATION REQUEST message) at least indicating a set of candidate cells (e.g. M candidate cells); and receive a second message (e.g. a UE CONTEXT MODIFICATION RESPONSE message) indicating a candidate cell configuration and an index of candidate cell configuration for each candidate cell of one or more candidate cells (e.g. N candidate cells) of the set of candidate cells.

In some embodiments, the first message (e.g. a UE CONTEXT MODIFICATION REQUEST message) further indicates a candidate cell configuration for each candidate cell of the set of candidate cells, the CU is further configured to: transmit, to a DU, a request message indicating at least one candidate cell (e.g. K candidate cells, where K is an integer); and receive a response message indicating a candidate cell configuration for each candidate cell of at least a part of the at least one candidate cell (e.g. L candidate cells, where L is an integer, and L≤K).

In some embodiments, the first message further indicates an index for each candidate cell configuration for each candidate cell of a set of candidate cells.

In some embodiments, the CU may determine an index for each candidate cell configuration for each candidate cell of at least a part of the at least one candidate cell.

In some embodiments, the CU may transmit, to a candidate DU, a request message (e.g. a UE CONTEXT SETUP REQUEST message) indicating at least one candidate cell and an index range; and receive a response message (e.g. a UE CONTEXT SETUP RESPONSE message) indicating a candidate cell configuration and an index of candidate cell configuration for each candidate cell of at least a part of the at least one candidate cell.

In some embodiments, the CU may transmit, to a UE, a message (for example, a RRCReconfiguration message) indicating the candidate cell configuration and the index of candidate cell configuration for each candidate cell of one or more candidate cells.

FIG. 4 illustrates a method performed by a UE according to some embodiments of the present disclosure.

In operation 401, the UE may receive, a message (for example, a RRCReconfiguration message) indicating a candidate cell configuration and an index of candidate cell configuration for each candidate cell of one or more candidate cells; and in operation 402, in response to receiving an indication indicating the UE to handover from a serving cell to a candidate cell of the one or more candidate cells, the UE may perform a random access procedure towards the candidate cell.

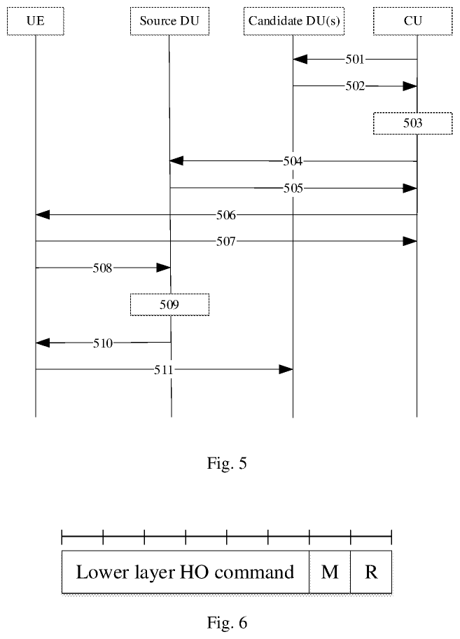

FIG. 5 illustrates a flow chart of supporting lower layer mobility in an inter-DU mobility scenario according to some embodiments of the present disclosure.

In FIG. 5, four components are included, a UE, a source DU, one or more candidate DUs (which are referred to as “candidate DU(s) in FIG. 5), and a CU. The source DU and the one or more candidate DUs are within the CU, and the UE is moving from the source DU to one of the one or more candidate DUs. The source DU manages the serving cell of the UE, and one of the one or more candidate DUs manages the candidate cell that the UE is handover to. In some embodiments, the candidate cell that the UE is handover to may be referred to as the “candidate target cell.”

In this solution, the index of the candidate cell configuration is generated by the CU. The candidate DU(s) (one or more candidate DUs) may provide the cell configuration for each candidate cell to the CU. In response to reception of the cell configuration of candidate cells (in short, candidate cell configurations), the CU may generate (or assign) an index for each candidate cell configuration. The CU may send the candidate cell configuration(s) and the generated index(s) to the source DU. The CU may also send the candidate cell configuration(s) and the generated index(s) to the UE. The detailed flows are presented as follows.

In operation 501, the CU may transmit a message, e.g. a UE CONTEXT SETUP REQUEST message, indicating a number of candidate cell IDs (denoted as K candidate cell IDs for simplicity), to a candidate DU (or to multiple candidate DUs). It should be noted that the K candidate cells may be controlled by the same candidate DU, or by different candidate DUs. The message may request the preparation of K candidate cells controlled by the candidate DU(s), to create a UE context and setup one or more data bearers.

In some embodiments, the UE CONTEXT SETUP REQUEST message may be sent for each candidate cell. That is, the CU may transmit K UE CONTEXT SETUP REQUEST messages, where each UE CONTEXT SETUP REQUEST message may indicate a candidate cell ID.

In some another embodiments, the UE CONTEXT SETUP REQUEST message may include multiple candidate cell IDs (e.g., a list of K candidate cell IDs), and is transmitted to the candidate DU(s) which controls and the multiple candidate cells.

In operation 502, if the preparation request is accepted, the candidate DU(s) may transmit a response message to the CU, for example, a UE CONTEXT SETUP RESPONSE message. The UE CONTEXT SETUP RESPONSE message may indicate the candidate cell ID(s) that was requested from the CU, as well as the candidate cell configuration.

The candidate cell configuration may include the cell configuration used for the lower layer mobility. For example, the candidate cell configuration may include at least one of the following:
a CSI resource configuration, which may be referred to as: CSI-ResourceConfig; or
a state of TCI, which associates one or two downlink reference signals with a corresponding quasi-colocation type.

The CSI resource configuration may define at least one of the following in the candidate cell: 1) a group of one or more non-zero-power (NZP) CSI reference signal (RS) resource sets, which may be referred to as: NZP-CSI-RS-ResourceSet, 2), a CSI interference management (IM) resources set, which may be referred to as: CSI-IM-ResourceSet, or 3), a CSI synchronization signal/physical broadcast channel (SSB) resource set, which may be referred to as: CSI-SSB-ResourceSet.

The NZP-CSI-RS-ResourceSet is a set of NZP CSI-RS resources and set-specific parameters, where each NZP CSI-RS resource is used to configure NZP CSI-RS transmitted in the cell where the UE may be configured to measure. The CSI-IM-ResourceSet is used to configure a set of one or more CSI IM resources and set-specific parameters. The CSI-SSB-ResourceSet is used to configure one SS/PBCH block resource set.

Among the K requested candidate cells, some may be accepted, while the other may not. It is supposed that the total number of accepted candidate cells is denoted as L simplicity, wherein L may be an integer equal to or larger than one, and L≤K. The candidate DU(s) may transmit, e.g., UE CONTEXT SETUP RESPONSE message(s), indicating the L candidate cell configurations. In some embodiments, the UE CONTEXT SETUP RESPONSE message may be sent for each requested candidate cell, i.e., each UE CONTEXT SETUP RESPONSE message for one candidate cell, and the candidate DU(s)may send L UE CONTEXT SETUP RESPONSE messages to the CU. In some another embodiments, in the case there is one candidate DU, the one candidate DU may transmit one UE CONTEXT SETUP RESPONSE message indicating L candidate cell configurations. In some other embodiments, each candidate DU of the multiple DUs may transmit one UE CONTEXT SETUP RESPONSE message indicating all candidate cell configurations of itself to the CU.

In operation 503, after receiving the L candidate cell configurations, the CU may generate an index for each candidate cell configuration of the L candidate cell configurations, where the index is used to identify a candidate cell configuration.

For example, the index may be a numerical value, e.g., 0, 1, 2, 3, etc. The maximum value of the index may be pre-configured, such as 8, 16, 32, 64, 128, etc. For another example, the index may be a candidate cell configuration ID, which is used to identify a candidate cell configuration.

In operation 504, the CU may transmit a message, for example, a UE CONTEXT MODIFICATION REQUEST message or a DL RRC MESSAGE TRANSFER message, to the source DU, which may indicate a number of candidate cell configurations (denoted as M candidate cell configurations for simplicity, wherein M may be an integer equal to or larger than one) and the corresponding indexes. The M candidate cell configurations may be from one candidate DU, or from multiple candidate DUs. For simplicity, the UE CONTEXT MODIFICATION REQUEST message is used to describe the solution.

In some embodiments, the UE CONTEXT MODIFICATION REQUEST message may be sent for each candidate cell. That is, the CU may send M UE CONTEXT MODIFICATION REQUEST messages, where each UE CONTEXT MODIFICATION REQUEST message may indicate one candidate cell configuration and the corresponding index.

In some another embodiments, the UE CONTEXT MODIFICATION REQUEST message may indicate multiple candidate cell configurations and the corresponding indexes (e.g., a list of M candidate cell configurations and the corresponding indexes), and is transmitted to the source DU.

In some cases, the CU may identify a potential set of candidate cells from the L candidate cells to which the UE may be handover, e.g., based on the reported L3 measurements. In this case, M is smaller than the total number of candidate cells from the one or more candidate DU(s), i.e. M≤L.

In operation 505, if the modification request is accepted, the source DU may transmit a response message to the CU, for example: a UE CONTEXT MODIFICATION RESPONSE message or a UL RRC MESSAGE TRANSFER message, which may indicate N candidate cell configurations and the corresponding indexes are accepted, where N≤M.

In some embodiments, the UE CONTEXT MODIFICATION RESPONSE message may be sent for each accepted candidate cell. That is, the source DU may transmit M UE CONTEXT MODIFICATION RESPONSE messages, where each UE CONTEXT MODIFICATION RESPONSE message may indicate one accepted candidate cell configuration and the corresponding index.

In some other embodiments, the UE CONTEXT MODIFICATION RESPONSE message may include a list of N accepted candidate cell IDs, which may indicate the candidate cell configurations and indexes are accepted, where N≤M. Alternatively, the UE CONTEXT MODIFICATION RESPONSE message may indicate N candidate cell configurations and the corresponding indexes, where N≤M.

In operation 506, having received N candidate cell configurations and the corresponding indexes from the source DU, the CU may generate the required RRC reconfiguration and send a RRC reconfiguration message to the UE. The RRC reconfiguration message may indicate the N candidate cell configurations and the corresponding indexes.

In some embodiments, the CU may send a number of candidate cells configurations (the number may be equal to or smaller than N) and the corresponding indexes to the UE. For example, the CU may exclude some candidate cells (the number of these candidate cell is denoted as A for simplicity, wherein A may be an integer equal to or larger than one) that the UE may not handover to, and then send information of the N-A candidate cells including N-A candidate cell configurations and the corresponding N-A indexes to the UE.

In operation 507, the UE may respond the CU with the RRC reconfiguration complete message, which may be represented as: RRCReconfigurationComplete.

In operation 508, the UE may start to report the L1 measurements of the serving cell and candidate cells to the source DU.

In operation 509, the source DU may determine that the lower layer mobility to a candidate cell is needed.

In operation 510, the source DU may send an indication to the UE, for example, a lower layer mobility command, to trigger the UE to handover from the current serving cell to the candidate cell. The candidate cell may also be referred to as the candidate target cell. The indication may be transmitted via a MAC CE, or DCI, or other messages or signalling.

The indication may indicate an index, which may indicate a candidate cell configuration that will be applied (or used, or activated) by the UE when the UE receives the indication. The indication may further include an indicator which may indicate whether the candidate cell configuration will be maintained by the UE when the UE connects to the candidate cell.

In operation 511, the UE may perform a random access procedure towards the target cell, which is indicated by the source DU.

FIG. 6 illustrates a structure of an indication according to some embodiments of the present disclosure.

In FIG. 6, the indication may be a MAC CE command, which has a fixed size of one octet. In particular, the octet may include at least one of the following:
Lower layer handover (HO) command: this field may indicate the index value used for the candidate cell configuration that the UE has to apply. The size of the field may be 6 bits.
M: this field may indicate whether the candidate cell configuration will be maintained by the UE when the UE connects to the candidate cell. The length of the field may be 1 bit. If the M field is set to 1, the candidate cell configuration will be maintained by the UE.
R: a reserved bit, which may be set to 0.

The MAC CE for the indication may have a logical channel ID (LCID) value in the MAC sub header. For example, the codepoint of 35 is used for the indication. Other codepoint may also be used for the indication.

The MAC CE depicted in FIG. 6 is an example of the structure of the MAC CE, other formats of the MAC CE may also be used. For example, the MAC CE may consist of two octets, three octets, the size of the lower layer HO command field may be 3 bits, etc.

In some other embodiments, the indication may be a DCI command. For example, a DCI format 2_8 may be used for indicating the candidate cell configuration where the UE has to apply and optionally whether the candidate cell configuration will be maintained by the UE when the UE connects to the candidate cell. At least one of the following information is transmitted by DCI format 2_8:
Lower layer handover (HO) command: this field may indicate the index value used for the candidate cell configuration that the UE has to apply. The size of the field may be 6 bits.
M: this field may indicate whether the candidate cell configuration will be maintained by the UE when the UE connects to the candidate cell. The length of the field may be 1 bit. If the M field is set to 1, the candidate cell configuration will be maintained by the UE.

The DCI format 2_8 is an example of the structure of the DCI, other formats of the DCI may also be used. For example, the size of the lower layer HO command field may be 3 bits, etc.

As can be seen, one octet may be sufficient for indicating the candidate cell configuration, compared to legacy L3 signalling, wherein the cell ID with 32 bits and physical cell identity (PCI) with 10 bits are used, and the solution of the present application significantly reduces the signalling overhead.

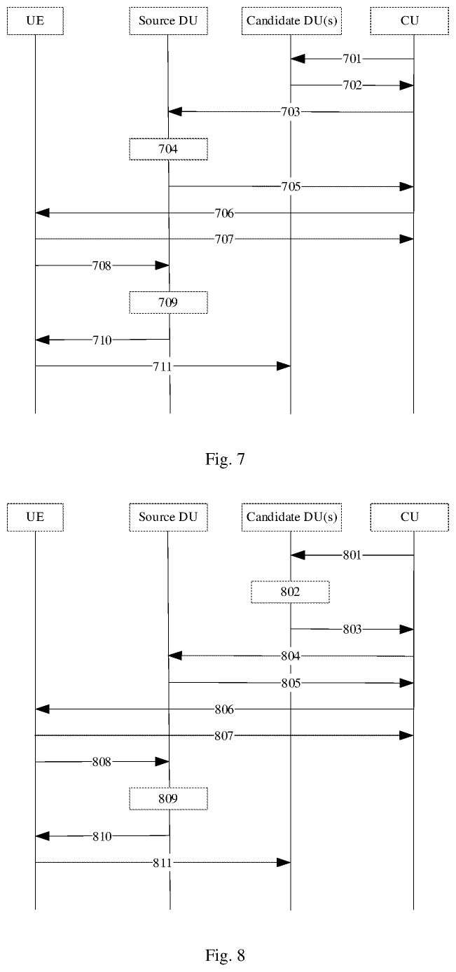

FIG. 7 illustrates a flow chart of supporting lower layer mobility in an inter-DU mobility scenario according to some embodiments of the present disclosure. The components included in FIG. 7 are similar to those in FIG. 5, and details are omitted here.

In this solution, the index of the candidate cell configuration for each candidate cell is generated by the source DU. The candidate DU(s) may provide the candidate cell configuration(s) to the CU. The CU may send the candidate cell configuration(s) from the candidate DU(s) to the source DU. In response to reception of candidate cell configuration(s), the source DU may generate (or assign) an index for each candidate cell configuration. The source DU may send the candidate cell configuration(s) and the generated index(s) to the CU. The CU may send the candidate cell configuration(s) and the generated index(s) to the UE. The detailed flows are presented as follows.

Operations 701, 702, and 706 to 711 are similar to operations 501, 502, and 506 to 511 as described in FIG. 5 respectively, and details are omitted here.

In operation 703, the CU may transmit a message, for example, a UE CONTEXT MODIFICATION REQUEST message or a DL RRC MESSAGE TRANSFER message, to the source DU, which may indicate M candidate cell configurations. The M candidate cell configurations may be from one candidate DU, or from multiple candidate DUs.

In some embodiments, the UE CONTEXT MODIFICATION REQUEST message may be sent for each candidate cell. That is, the CU may send M UE CONTEXT MODIFICATION REQUEST messages, where each UE CONTEXT MODIFICATION REQUEST message may indicate one candidate cell configuration.

In some another embodiments, the UE CONTEXT MODIFICATION REQUEST message may include multiple candidate cell configurations (e.g., a list of M candidate cell configurations), and is transmitted to the source DU.

In another example, the CU may identify a potential set of candidate cells to which the UE may be handover, e.g., based on the reported L3 measurements. In this case, M is smaller than the total number of candidate cells (i.e. L) from the one or more candidate DU(s), i.e. M≤L.

In operation 704, after receiving the M candidate cell configurations, the source DU may generate an index for each candidate cell configuration of the M candidate cell configurations, where the index is used to identify a candidate cell configuration.

For example, the index may be a numerical value, e.g., 0, 1, 2, 3, etc. The maximum value of the index may be pre-configured, such as 8, 16, 32, 64, 128, etc. For another example, the index may be a candidate cell configuration ID, which is used to identify a candidate cell configuration.

In operation 705, the modification request may be accepted, and the source DU may transmit a response message to the CU, for example: a UE CONTEXT MODIFICATION RESPONSE message or a UL RRC MESSAGE TRANSFER message, which may indicate that N candidate cell configurations and the corresponding indexes are accepted, where N≤M.

In some embodiments, the UE CONTEXT MODIFICATION RESPONSE message may be sent for each accepted candidate cell. That is, the source DU may transmit N UE CONTEXT MODIFICATION RESPONSE messages, where each UE CONTEXT MODIFICATION RESPONSE message may indicate one accepted candidate cell configuration and the corresponding generated index.

In some another embodiments, the UE CONTEXT MODIFICATION RESPONSE message may include a list of N accepted candidate cell IDs and the corresponding generated indexes, which may indicate the candidate cell configurations and indexes are accepted, where N≤M. Alternatively, the UE CONTEXT MODIFICATION RESPONSE message may include N candidate cell configurations and the corresponding generated indexes, where N≤M.

FIG. 8 illustrates a flow chart of supporting lower layer mobility in an inter-DU mobility scenario according to some embodiments of the present disclosure. The components included in FIG. 8 are similar to those in FIG. 5, and details are omitted here.

In this solution, the index of the candidate cell configuration is generated by the candidate DU (or each of multiple candidate DUs). The CU may assign an index range for the candidate cell configuration(s) of each candidate DU. The candidate DU (or each of multiple candidate DUs) may select an index from the index range for each candidate cell configuration, and send the selected index(s) and the corresponding candidate cell configuration(s) to the CU. The CU may send the index(s) and the corresponding candidate cell configurations received from the candidate DU (or multiple candidate DUs) to the source DU. The CU may also send the index(s) and the corresponding candidate cell configuration(s) to the UE. The detailed flows are presented as follows.

In operation 801, the CU may transmit a message, e.g. a UE CONTEXT SETUP REQUEST message, including a number of candidate cell IDs (denoted as K candidate cell IDs for simplicity, wherein K may be an integer equal to or larger than one), to candidate DU(s). It should be noted that the K candidate cells may be controlled by the same candidate DU, or by different candidate DUs. The message may also indicate the index range assigned by the CU where the indexes within the index range could be used by the candidate DU.

In some embodiments, the UE CONTEXT SETUP REQUEST message may be sent for each candidate cell. That is, the CU may transmit K UE CONTEXT SETUP REQUEST messages, where each UE CONTEXT SETUP REQUEST message may indicate a candidate cell ID and the index range.

In some another embodiments, the UE CONTEXT SETUP REQUEST message may indicate multiple candidate cell IDs (e.g., a list of K candidate cell IDs) and the index range, and is transmitted to the candidate DU(s) which may control the multiple candidate cells.

In operation 802, the preparation request may be accepted. The candidate DU(s) may prepare the candidate cell configuration(s), and select an index from the index range for each candidate cell configuration.

For example, one index range may be from 0-5, and the selected index may be numerical value, e.g., 0, 1, 2, 3, etc. The maximum value of the index range may be pre-configured, such as 8, 16, 32, 64, 128, etc. For another example, the index range may be a set of candidate cell configuration IDs, and the selected index may be one ID from the set, which is used to identify a candidate cell configuration.

In operation 803, the candidate DU(s) may transmit a response message to the CU, for example, a UE CONTEXT SETUP RESPONSE message. The UE CONTEXT SETUP RESPONSE message may indicate the candidate cell ID(s) that was requested from the CU, the candidate cell configuration(s), and the corresponding selected index(s) of the candidate cell configuration for each candidate cell.

Among the K requested candidate cells, some may be accepted, while the other may not. It is supposed that the number of accepted candidate cells is denoted as L, and L≤K. The candidate DU(s) may transmit UE CONTEXT SETUP RESPONSE message(s) indicating the L candidate cell configurations and the corresponding L selected indexes. In some embodiments, the UE CONTEXT SETUP RESPONSE message may be sent for each requested candidate cell, i.e., each UE CONTEXT SETUP RESPONSE message for one candidate cell, and the candidate DU(s) may send L UE CONTEXT SETUP RESPONSE messages to the CU. In some another embodiments, in the case there is one candidate DU, the one candidate DU may transmit one UE CONTEXT SETUP RESPONSE message indicating L candidate cell configurations and the corresponding selected index(s). In some other embodiments, each candidate DU of the multiple DUs may transmit one UE CONTEXT SETUP RESPONSE message indicating all candidate cell configurations of itself and the corresponding selected index(s) to the CU.

Operations 804 to 811 are similar to operations 504 to 511 as described in FIG. 5 respectively, and details are omitted here.

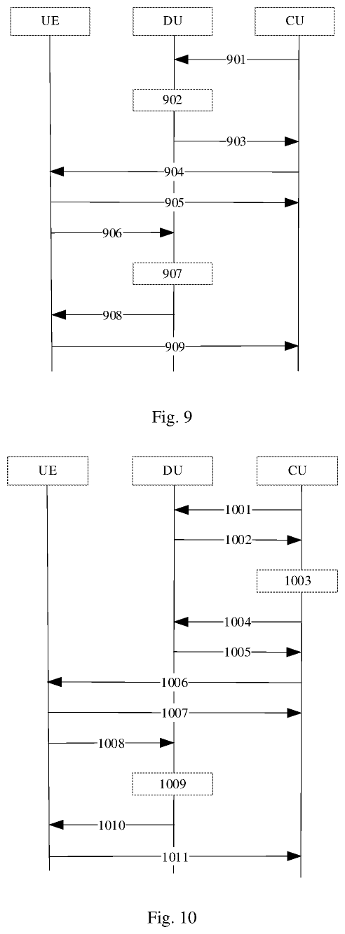

FIG. 9 illustrates a flow chart of supporting lower layer mobility in an intra-DU mobility scenario according to some embodiments of the present disclosure. In FIG. 9, three components are included, a UE, a DU, and a CU. The DU may also be referred to as the source DU, and the UE is performing a handover procedure from a source cell to a target cell, and both cells are managed by the DU.

In this solution, the index is generated by the DU. The DU may provide the candidate cell configuration as well as the index for each candidate cell configuration to the CU. The CU may send the index(s) and the corresponding candidate cell configuration(s) to the UE. The detailed flows are presented as follows.

In operation 901, the CU may transmit a message, for example, a UE CONTEXT MODIFICATION REQUEST message, to the DU, which may include M candidate cell IDs. The CU may request the preparation of M candidate cells by sending the message to the DU to modify UE context.

In some embodiments, the UE CONTEXT MODIFICATION REQUEST message may be sent for each candidate cell. That is, the CU may send M UE CONTEXT MODIFICATION REQUEST messages, where each UE CONTEXT MODIFICATION REQUEST message may include one candidate cell ID.

In some another embodiments, the UE CONTEXT MODIFICATION REQUEST message may include multiple candidate cell IDs (e.g., a list of M candidate cell configurations), and is transmitted to the DU.

In operation 902, the modification request may be accepted, for example, N candidate cells among the M are accepted, where N≤M, the DU may prepare the N candidate cell configurations, and generate an index for each candidate cell configuration of the N candidate cell configurations, where the index is used to identify a candidate cell configuration. In some embodiments, the index may be a numerical value, e.g., 0, 1, 2, 3, etc. The maximum value of the index may be pre-configured, such as 8, 16, 32, 64, 128, etc. In other embodiments, the index may be a candidate cell configuration ID, which is used to identify a candidate cell configuration.

In operation 903, the DU may transmit a response message to the CU, for example: a UE CONTEXT MODIFICATION RESPONSE message, which may indicate N candidate cell configurations and the corresponding indexes.

In some embodiments, the UE CONTEXT MODIFICATION RESPONSE message may be sent for each accepted candidate cell. That is, the DU may transmit N UE CONTEXT MODIFICATION RESPONSE messages, where each UE CONTEXT MODIFICATION RESPONSE message may indicate one accepted candidate cell configuration and the corresponding index.

In some another embodiments, the UE CONTEXT MODIFICATION RESPONSE message may indicate N candidate cell configurations and the corresponding indexes, where N≤M.

Operations 904 to 909 are similar to operations 506 to 511 as described in FIG. 5 respectively, and details are omitted here.

FIG. 10 illustrates a flow chart of supporting lower layer mobility in an intra-DU mobility scenario according to some embodiments of the present disclosure. The components included in FIG. 10 are similar to those in FIG. 9, and details are omitted here.

In this solution, the index is generated by the CU. The DU may provide the cell configuration for each candidate cell to the CU. In response to reception of the candidate cell configuration(s), the CU may generate (or assign) an index for each candidate cell configuration. The CU may send the candidate cell configuration(s) and the generated index(s) to the DU. The CU may also send the candidate cell configuration(s) and the generated index(s) to the UE. The detailed flows are presented as follows.

In operation 1001, the CU may transmit a message, for example, a UE CONTEXT MODIFICATION REQUEST message, to the DU, which includes K candidate cell IDs. The CU may request the preparation of K candidate cells by sending the message to the DU to modify UE context.

In some embodiments, the UE CONTEXT MODIFICATION REQUEST message may be sent for each candidate cell. That is, the CU may send K UE CONTEXT MODIFICATION REQUEST messages, where each UE CONTEXT MODIFICATION REQUEST message may indicate a candidate cell ID.

In some another embodiments, the UE CONTEXT MODIFICATION REQUEST message may include multiple candidate cell IDs (e.g., a list of M candidate cell configurations) to the DU.

In operation 1002, if the modification request is accepted, for example, L candidate cells among the K are candidate cells accepted, where L≤K, the DU may transmit a response message to the CU, for example, a UE CONTEXT MODIFICATION RESPONSE message. The UE CONTEXT MODIFICATION RESPONSE message may include the candidate cell configuration for each of the L candidate cells.

In operation 1003, after receiving the L candidate cell configuration(s), the CU may generate an index for each candidate cell configuration of the L candidate cell configurations, where the index is used to identify a candidate cell configuration.

In operation 1004, the CU may transmit a message, for example, a UE CONTEXT MODIFICATION REQUEST message, to the DU, which may indicate M candidate cell configurations and the corresponding indexes.

In some embodiments, the UE CONTEXT MODIFICATION REQUEST message may be sent for each candidate cell. That is, the CU may send M UE CONTEXT MODIFICATION REQUEST messages, where each UE CONTEXT MODIFICATION REQUEST message includes one candidate cell configuration and the corresponding index.

In some another embodiments, the UE CONTEXT MODIFICATION REQUEST message may include multiple candidate cell configurations and the corresponding indexes (e.g., a list of M candidate cell configurations and the corresponding indexes) to the source DU.

In operation 1005, if the modification request is accepted, the source DU may transmit a response message to the CU, for example: a UE CONTEXT MODIFICATION RESPONSE message, which may indicate N candidate cell configurations and the corresponding indexes are accepted.

In some embodiments, the UE CONTEXT MODIFICATION RESPONSE message may be sent for each accepted candidate cell. That is, the DU may transmit N UE CONTEXT MODIFICATION RESPONSE messages, where each UE CONTEXT MODIFICATION RESPONSE message may indicate one accepted candidate cell configuration and the corresponding index.

In some another embodiments, the UE CONTEXT MODIFICATION RESPONSE message may indicate a list of N accepted candidate cell IDs, which may indicate the candidate cell configurations and indexes are accepted, where N≤M. Alternatively, the UE CONTEXT MODIFICATION RESPONSE message may indicate N candidate cell configurations and the corresponding indexes, where N≤M.

Operations 1006 to 1011 are similar to operations 506 to 511 as described in FIG. 5 respectively, and details are omitted here.

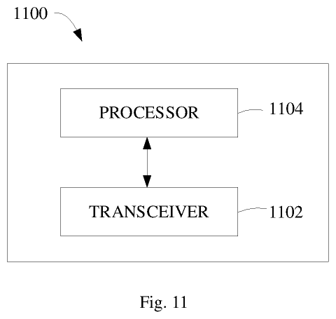

FIG. 11 illustrates a simplified block diagram of an apparatus according to some embodiments of the present disclosure.

As shown in FIG. 11, an example of the apparatus 1100 may include at least one processor 1104 and at least one transceiver 1102 coupled to the processor 1104. The apparatus 1100 may be a UE, a BS, a CU, a candidate DU, a source DU, a target DU, a candidate target DU, or any other device with similar functions.

Although in this figure, elements such as the at least one transceiver 1102 and processor 1104 are described in the singular, the plural is contemplated unless a limitation to the singular is explicitly stated. In some embodiments of the present disclosure, the transceiver 1102 may be divided into two devices, such as a receiving circuitry and a transmitting circuitry. In some embodiments of the present disclosure, the apparatus 1100 may further include an input device, a memory, and/or other components.

In some embodiments of the present disclosure, the apparatus 1100 may be a UE. The transceiver 1102 and the processor 1104 may interact with each other so as to perform the operations of the UE described in any of FIGS. 1-10. In some embodiments of the present disclosure, the apparatus 1100 may be a CU, a candidate DU, a source DU, a target DU, a candidate target DU, or the like. The transceiver 1102 and the processor 1104 may interact with each other so as to perform the operations of the node described in any of FIGS. 1-10.

In some embodiments of the present disclosure, the apparatus 1100 may further include at least one non-transitory computer-readable medium.

For example, in some embodiments of the present disclosure, the non-transitory computer-readable medium may have stored thereon computer-executable instructions to cause the processor 1104 to implement the method with respect to the UE as described above. For example, the computer-executable instructions, when executed, cause the processor 1104 interacting with transceiver 1102 to perform the operations of the UE described in any of FIGS. 1-10.

In some embodiments of the present disclosure, the non-transitory computer-readable medium may have stored thereon computer-executable instructions to cause the processor 1104 to implement the method with respect to a CU, a candidate DU, a source DU, a target DU, or a candidate target DU as described above. For example, the computer-executable instructions, when executed, cause the processor 1104 interacting with transceiver 1102 to perform the operations of the node described in any of FIGS. 1-10.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “including.”

What is claimed is:

1. A distributed unit (DU) for wireless communication, comprising:
at least one memory; and
at least one processor coupled with the at least one memory and operable to cause the DU to:
determine a candidate cell configuration and an index of the candidate cell configuration for each candidate cell of one or more candidate cells, wherein the index of the candidate cell configuration is generated by the DU or received from other network node; and
transmit, to a user equipment (UE), an indication indicating the UE to handover from a serving cell to a candidate cell of the one or more candidate cells.

2. The DU of claim 1, wherein the indication is transmitted via medium access control (MAC)-control element (CE) or downlink control information (DCI).

3. The DU of claim 1, wherein the indication indicates at least one of following:
an index of a candidate cell configuration corresponding to the candidate cell; or
an indicator indicating whether the candidate cell configuration is to be maintained.

4. The DU of claim 1, wherein the at least one processor is operable to cause the DU to:
receive, from a central unit (CU), a first message indicating a candidate cell configuration and an index of candidate cell configuration for each candidate cell of a set of candidate cells, wherein the set of candidate cells includes the one or more candidate cells; and
transmit, to the CU, a second message indicating the candidate cell configuration and the index of the candidate cell configuration for each candidate cell of the one or more candidate cells.

5. The DU of claim 1, wherein the at least one processor is operable to cause the DU to:
receive, from a central unit (CU), a first message indicating a candidate cell configuration for each candidate cell of a set of candidate cells;
determine the one or more candidate cells from the set of candidate cells;
generate an index for each candidate cell configuration for each candidate cell of the one or more candidate cells; and
transmit, to the CU, a second message indicating the candidate cell configuration and the index of the candidate cell configuration for each candidate cell of the one or more candidate cells.

6. The DU of claim 1, wherein the at least one processor is operable to cause the DU to:
receive, from a central unit (CU), a first message indicating a set of candidate cells;
determine the one or more candidate cells from the set of candidate cells;
generate a candidate cell configuration and an index for each candidate cell configuration for each candidate cell of the one or more candidate cells; and
transmit, to the CU, a second message indicating the candidate cell configuration and the index of the candidate cell configuration for each candidate cell of the one or more candidate cells.

7. The DU of claim 4, wherein the at least one processor is operable to cause the DU to:
receive, from a central unit (CU), a first message indicating a set of candidate cells;
determine the one or more candidate cells from the set of candidate cells;
generate a candidate cell configuration for each candidate cell of the one or more candidate cells; and
transmit, to the CU, a second message indicating the candidate cell configuration for each candidate cell of the one or more candidate cells.

8. The DU of claim 1, wherein the candidate cell configuration includes at least one of
a channel state information (CSI) resource configuration; or
a state of transmission configuration indicator.

9. A central unit (CU) wireless communication, comprising:
at least one memory; and
at least one processor coupled with the at least one memory and operable to cause the CU to:
transmit a first message at least indicating a set of candidate cells; and
receive a second message indicating a candidate cell configuration and an index of candidate cell configuration for each candidate cell of one or more candidate cells of the set of candidate cells.

10. The CU of claim 9, wherein the first message further indicates a candidate cell configuration for each candidate cell of the set of candidate cells, and wherein the at least one processor is operable to cause the CU to:
transmit, to a candidate distributed unit (DU), a request message indicating at least one candidate cell; and
receive a response message indicating a candidate cell configuration for each candidate cell of at least a part of the at least one candidate cell.

11. The CU of claim 10, wherein the first message further indicates an index for each candidate cell configuration for each candidate cell of a set of candidate cells.

12. The CU of claim 11, wherein the at least one processor is operable to cause the CU to:
determine an index for each candidate cell configuration for each candidate cell of at least a part of the at least one candidate cell.

13. The CU claim 11, wherein the at least one processor is operable to cause the CU to:
transmit, to a candidate DU, a request message indicating at least one candidate cell and an index range; and
receive a response message indicating a candidate cell configuration and an index of candidate cell configuration for each candidate cell of at least a part of the at least one candidate cell.

14. The CU of claim 9, wherein the at least one processor is operable to cause the CU to:
transmit, to a UE, a message indicating the candidate cell configuration and the index of candidate cell configuration for each candidate cell of one or more candidate cells.

15. A user equipment (UE) for wireless communication, comprising:
at least one memory; and
at least one processor coupled with the at least one memory and operable to cause the UE to:
receive, a message indicating a candidate cell configuration and an index of candidate cell configuration for each candidate cell of one or more candidate cells; and
perform, based at least in part on receiving an indication indicating the UE to handover from a serving cell to a candidate cell of the one or more candidate cells, a random access procedure towards the candidate cell.

16. The UE of claim 15, wherein the indication is received via medium access control (MAC)-control element (CE) or downlink control information (DCI).

17. A method performed by a distributed unit (DU), the method comprising:
determining a candidate cell configuration and an index of the candidate cell configuration for each candidate cell of one or more candidate cells, wherein the index of the candidate cell configuration is generated by the DU or received from other network node; and
transmitting, to a user equipment (UE), an indication indicating the UE to handover from a serving cell to a candidate cell of the one or more candidate cells.

18. The method of claim 17, wherein the indication is transmitted via medium access control (MAC)-control element (CE) or downlink control information (DCI).

19. The method of claim 17, wherein the indication indicates at least one of:
an index of a candidate cell configuration corresponding to the candidate cell; or
an indicator indicating whether the candidate cell configuration is to be maintained.

20. The method of claim 17, wherein the candidate cell configuration includes at least one of:
a channel state information (CSI) resource configuration; or
a state of transmission configuration indicator.
